(19) United States
(12) Patent Application Publication
(10) Pub. No.: US 2007/0273693 A1
(43) Pub. Date: Nov. 29, 2007

(54) MACRO-LEVEL DIGITAL DATA EVENT DISPLAY

(75) Inventor: Glenn R. JOHNSON, Aloha, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 11/751,541

(22) Filed: May 21, 2007

Related U.S. Application Data
(60) Provisional application No. 60/808,029, filed on May 23, 2006.
(60) Provisional application No. 60/808,030, filed on May 23, 2006.

(51) Int. Cl. G06T 11/20

(52) U.S. Cl. 345/440

(57) ABSTRACT

A macro-level digital data event display provides event-based views of the digital, either in the form of a state machine representation or in the form of events versus time. Events within the digital data are defined, including assigning a specific color as desired. The digital data is parsed to locate each of the defined events, to determine the number of times unique transitions between events occur, and to measure the amount of time spent within each defined event. The events may be displayed as a graph with event labels along one axis representing lines that extend along another axis representing time, with a bar that transitions between lines when one event changes to another in sequence within the digital data, the length of the bar indicating the time spent in each event. Alternatively the events may be presented graphically as graphic symbols with lines between them representing the transitions from one event to another, the color of the lines representing the number of times the particular transition occurred within the digital data.

### CROSS-REFERENCE TO RELATED APPLICATIONS

The present non-provisional application claims the benefit of the filing date of co-pending provisional application Ser. No. 60/808,030 entitled “Displaying Data as Events Versus Time in a Logic Analyzer” filed May 23, 2006 and 60/808,029 entitled “Displaying Digital Data as Event Flow Sequences in a Logic Analyzer” filed May 23, 2006, which provisional applications are abandoned with the filing of the present non-provisional application.

### BACKGROUND OF THE INVENTION

The present invention relates to the display of large amounts of digital data, and more particularly to a macro-level digital data event display.

Instruments that acquire large amounts of digital data for analysis, such as logic analyzers, traditionally display the raw acquired data. The basic views of the data for display are waveform and listing. To both of these views symbolic names have been added to help a user understand the data. FIG. 1 shows a listing view that has symbolic names added to the address and data columns, such as “taskIdCurrent” and “tWSReader” respectively for example. The listing also shows a timestamp that indicates the time that has occurred from the previous task or event to the current task or event. An event or task may be as narrow as a single address or as broad as a defined sequence of state changes. The listing view shows in this example forty-eight (48) rows, and realistically this may be increased only to about sixty-five (65) rows on typical displays before the rows become virtually unreadable. Therefore the listing view limits the timespan that may be easily observed, and does not give a “feel” for the timing between tasks.

The list view of FIG. 1 has a trigger cursor that indicates that the data acquisition was triggered by the event at line 7, “yQA.” A start cursor [1] and an end cursor [2] define a range of events from line 6 through line 18, which events define the activity associated with the event “yQA.” Line 0 indicates that the current task at the beginning of the acquired digital data was “tWSReader”, line 1 indicates that after 484.5 usec the task changed from “tWSReader” to “tMonitor”. Likewise at line 3 after another 10.9 msec the task changed to “xCA.” The remainder of the list may be read accordingly. From what is shown the event sequence starting with “yQA” appears to be consistently the same, but what is shown is only a very small portion of the entire acquired digital data.

Recently logic analyzers have added color filtering to further help the user to understand the data at some higher level of abstraction, such as shown in FIG. 2 which is the same as FIG. 1 but with color highlighting. Color filtering brings a powerful feature to the user because events may be defined for highlighting or for removal from the listing view. This provides some detailed information to the user to the extent the user has some understanding of the context. But if the user is trying to find a problem at some unknown place in the listing view, it doesn't jump out at the user in 48 or 65 lines. In fact the listing view gets overwhelming and difficult to understand.

As indicated since each line is the same size regardless of the timestamp or amount of time the line represents, the user does not get a sense of the timing. For example in FIG. 1 a capture of a current task identification (ID) is being updated by a Real Time Operating System (RTOS). In this case the user is trying to find out in which tasks time is being spent as part of a throughput analysis. The user uses the timestamp column to determine the amount of time spent in any particular task, i.e., to determine the time spent in the “monitor” task of line 19 the user looks at the timestamp for line 20.

Waveform views do have an axis of time, as seen in FIGS. 3 and 4, plus some of the same features available in the listing views such as symbolic names and color highlighting. For the user the waveform view is very powerful when viewing a sequence of time. As shown separate waveforms are shown for the address bus, data bus and control bus data. Unfortunately the waveform view may hide important events when those events have a small amount of time. FIG. 4 has the same color filter applied as that for FIG. 2 and shows that big time sinks are “tMonitor” (shown for example in green) and “tWSReader” (shown for example in red), but the events of “xCA”, “tWSWriter” and tWSCmd” are lost in the noise or the “fuzz” of the waveform.

Therefore what is desired are new views for displaying the digital data that allows a macro-level view of the acquired digital data to be displayed in a meaningful manner without loss of detail.

### BRIEF SUMMARY OF THE PRESENT INVENTION

Accordingly the present invention provides a macro-level digital data event display that provides an event versus time view and an event flow sequence view for display. From knowledge of the device that provided the digital data events are defined. The events are then located within the digital data together with transition paths between sequential events and a duration spent in each event. From the located events and durations a graphic representation is produced that has the labeled events along one axis defining lines that define another axis representing time. A bar representing time spent in each event extends along each line, transitioning from one line to another as the events change in sequence. A plurality of events may be collapsed into a specified sequence represented by a single line to simplify the graph. The bar may be assigned a different color for each line, corresponding to a color assigned to the event for that line. For a sequence the bar may change color along the line as each event within the sequence changes. A similar graph for another set of digital data may be juxtaposed to show relationships between events occurring within the different sets of digital data. Alternatively the events may be represented by graphic symbols, such as bubbles, which are connected by lines representing the transition paths between events. The color of each line indicates the number of times the particular transition path occurred within the digital data. A key is provided that associates each unique line color with a range of values. With either of these views large amounts of the digital data may be readily analyzed and areas of interest quickly identified for closer analysis.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a listing view of digital data events according to the prior art.

FIG. 2 is a filtered listing view of digital data events that highlights events according to the prior art.

FIG. 3 is a waveform view of digital data events corresponding to the listing view of FIG. 1 according to the prior art.

FIG. 4 is a filtered waveform view of digital data events corresponding to the listing view of FIG. 2 according to the prior art.

FIG. 5 is a plan view of an event definition display according to the present invention.

FIG. 6 is a graphic view of an event driven data view corresponding to the listing of FIG. 1 according to the present invention.

FIG. 7 is a graphic view of a zoomed event driven data view according to the present invention.

FIG. 8 is a graphic view of a collapsed event driven data view according to the present invention.

FIG. 9 is a graphic view of current and external event driven data views according to the present invention.

FIG. 10 is a graphic view of an event flow view with basic elements according to the present invention.

FIG. 11 is a graphic view of an event flow view of a sequence of defined events according to the present invention.

FIG. 12 is a graphic view of an event flow view of a sequence of multiple defined events according to the present invention.

FIG. 13 is a graphic view of an event flow view of a multiple of same sequences of events with an exception according to the present invention.

FIG. 14 is a graphic view of an event flow view as a module state diagram derived from a listing view according to the present invention.

### DETAILED DESCRIPTION OF THE INVENTION

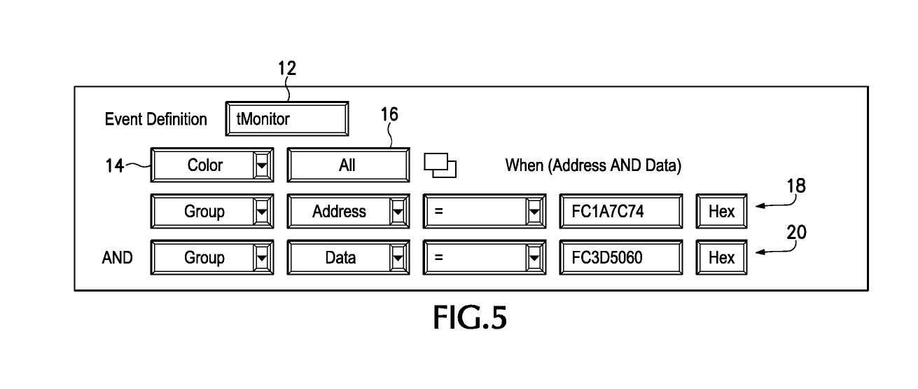

Referring now to FIG. 5 an event may be defined similar to the current color filter definitions used in logic analyzers, and as indicated above may be as narrow as a specified address or as broad as a defined sequence of state changes. The event definition comes from knowledge of the device under test, i.e., the device from which the digital data was acquired. In the following example for a particular task there are at least three types of events to define—an address that contains a “current” task and is modified for each task change, entry into an idle loop, and entry points into functions such as “X” and “Y” in this case. However the events may be defined by a search tool or event states and clauses of a trigger state machine that captures the digital data initially.

As shown an event is labeled “tMonitor” in an “Event Definition” box 12. A color may be assigned to the event in a color box 14, or all of the events may be assigned the same color in box 16. The event is then defined by an address row of boxes 18 and a data row of boxes 20. In this example the event “tMonitor” has an address of “FC1A7C74” and a data value of “FC3D5060”. Each event, such as “tWSReader”, “tWSWriter”, “yQA”, “xCA”, “tWSCmd”, “FDCwriter”, “ProbeMonitor”, etc., may be similarly defined. When an event is identified within the digital data it may be presented in a macro-level event view, such as the event versus time or event flow sequence views described below.

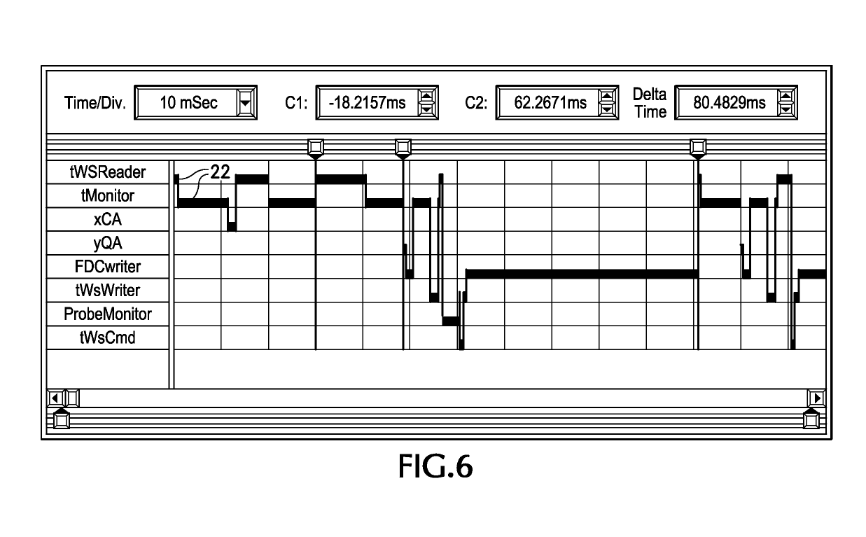

For displaying the event versus time or event driven data view as shown in FIG. 6 a separate line is reserved for each of the defined events, i.e., the events are listed along the y-axis. Starting with the first event in the listing view, in this case “tWSReader”, a bar 22 is drawn in the designated color until the next event is identified. The length of the bar is equal to the timestamp associated with the next event, in this case “tMonitor”. The bar is then switched to the next line associated with the next event until another event is identified. If the next event is an already identified event, then the bar 22 goes to the already existing line representing that event. This process continues through the entire acquired digital data. Unlike the waveform view the short events, such as “xCA”, “yCA”, “tWSWriter”, “tWSCmd”, etc., are readily apparent to the user as well as the sequence in which they occurred. Where the waveform view only showed clearly the “tWSReader”, “tMonitor” and “FDCwriter” events, the event driven data view clearly shows also the “xCA”, “yQA”, tWSWriter”, “ProbeMonitor” and “tWSCmd” events. Cursors corresponding to the cursors on the listing view show the trigger point for the data acquisition with the trigger cursor as well as the region of event activity indicated by respective start and end cursors so that the event driven data view may be correlated with the listing view.

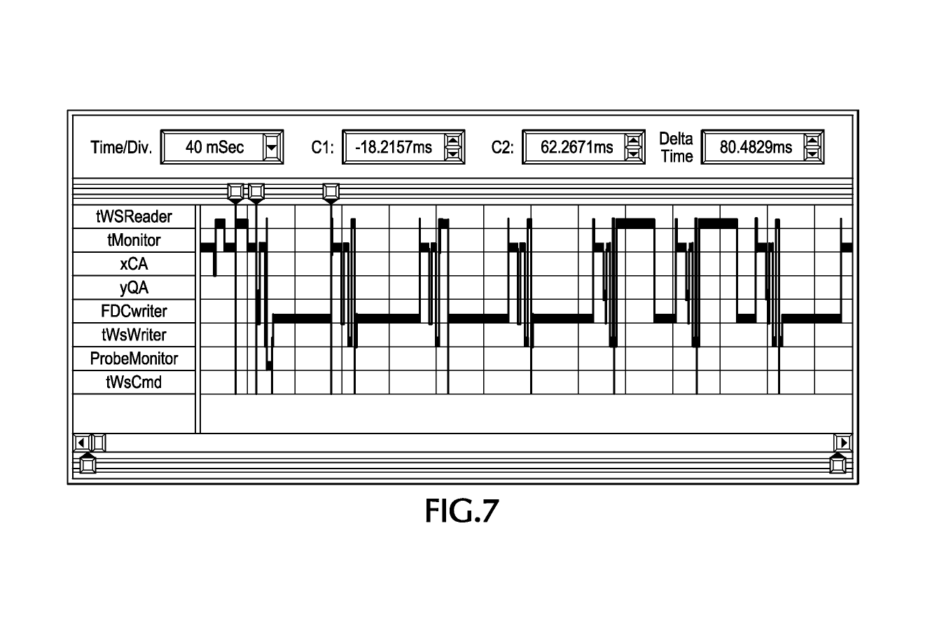

Changing the time scale for the event driven data view to “zoom” out, such as changing from 10 msec time/division to 40 msec time/division, results in the ability to see more than what is shown on a listing view, as shown in FIG. 7. In this instance all of the event activity is shown over a longer period of time than is encompassed in the listing view. A repeated pattern of event sequences is observable over the first four iterations, and then a different pattern occurs which may indicate an anomaly or region of interest. The user may then move the start and end cursors to encompass the region where the different pattern occurred, and return to the listing view that encompasses that region for greater details. In this way the user may readily scan the entire acquired digital data to locate regions of interest. The color filtering may be used to display each event in its unique color together with the associated bar.

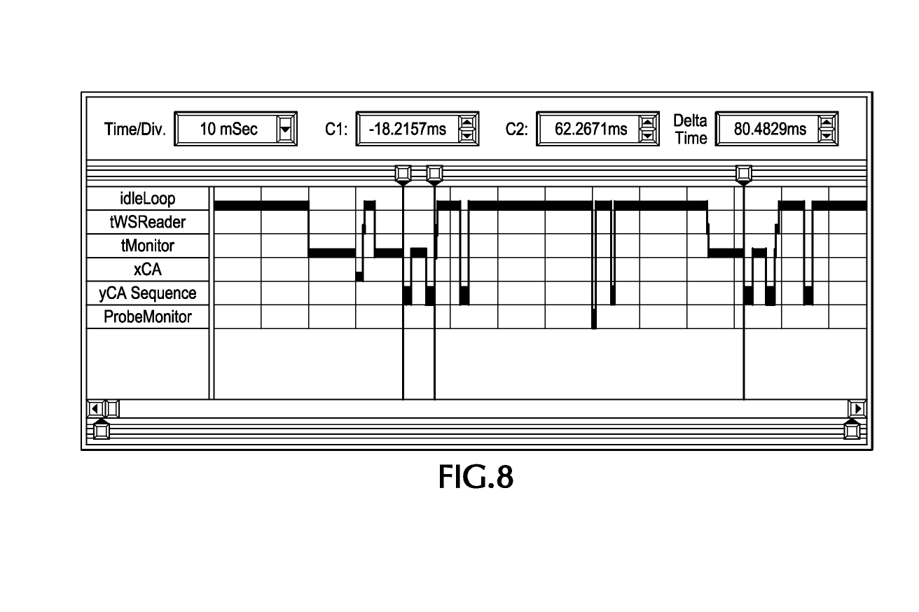

Even with the event driven data view too much data may be overwhelming. However the user may collapse adjacent events into a single line. As shown in FIG. 8 the events “yQA”, “FDCwriter”, “tWSWriter” and tWSCmd” are collapsed into a single line labeled “yCA Sequence”. The information is still apparent, as each event within the bar representing the sequence is coded in its own separate color, i.e., the color of the bar changes according to each event that occurs within the sequence. The collapse may be achieved by selecting the events and opening an option window to collapse the events into the indicated sequence. Similarly the user may select the sequence, open the option window and un-collapse the events back into multiple lines, one for each event. To further differentiate un-collapsed from collapsed events, the heights of the collapsed and un-collapsed events may be different. FIG. 8 shows the un-collapsed events with one-half the height of the collapsed events.

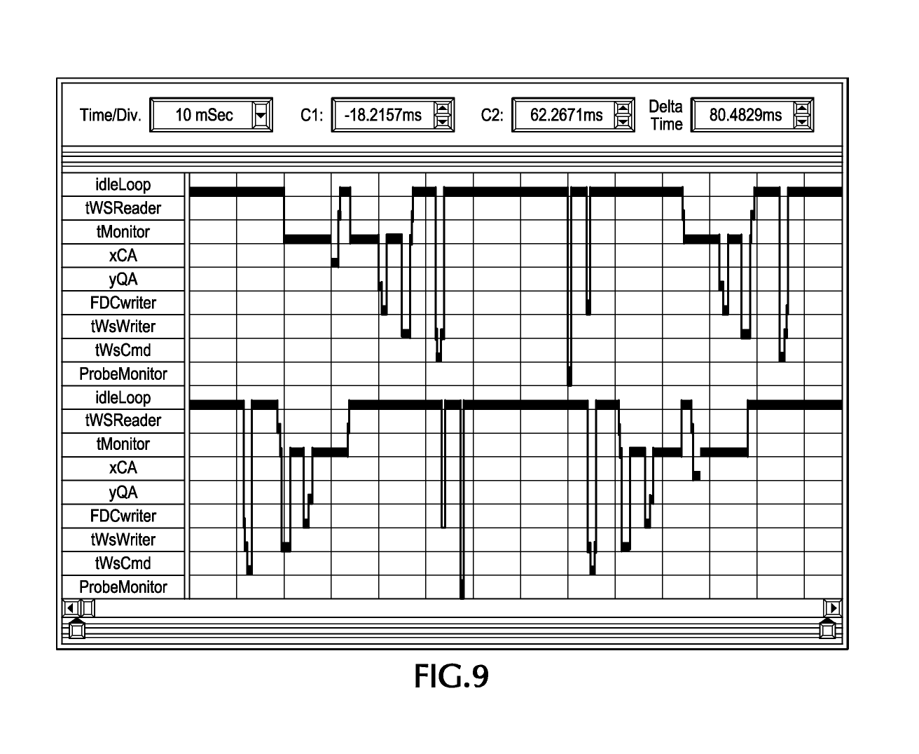

The event driven data view allows the acquired digital data from different acquisition modules to be shown together, as shown in FIG. 9. This allows the potentially different timebases of modules to be viewed in direct comparison with each other. As shown one event driven data view represents saved data and the other may be a current acquisition. These two acquisitions in this example should show the same sequence of events, but they are clearly different. The event views may just as well be the interaction between two sides of an interface, such as between two processors “talking” through a shared random access memory (RAM), with the digital data for each side being acquired by different timebases or modules. This gives a very graphic picture of what is occurring.

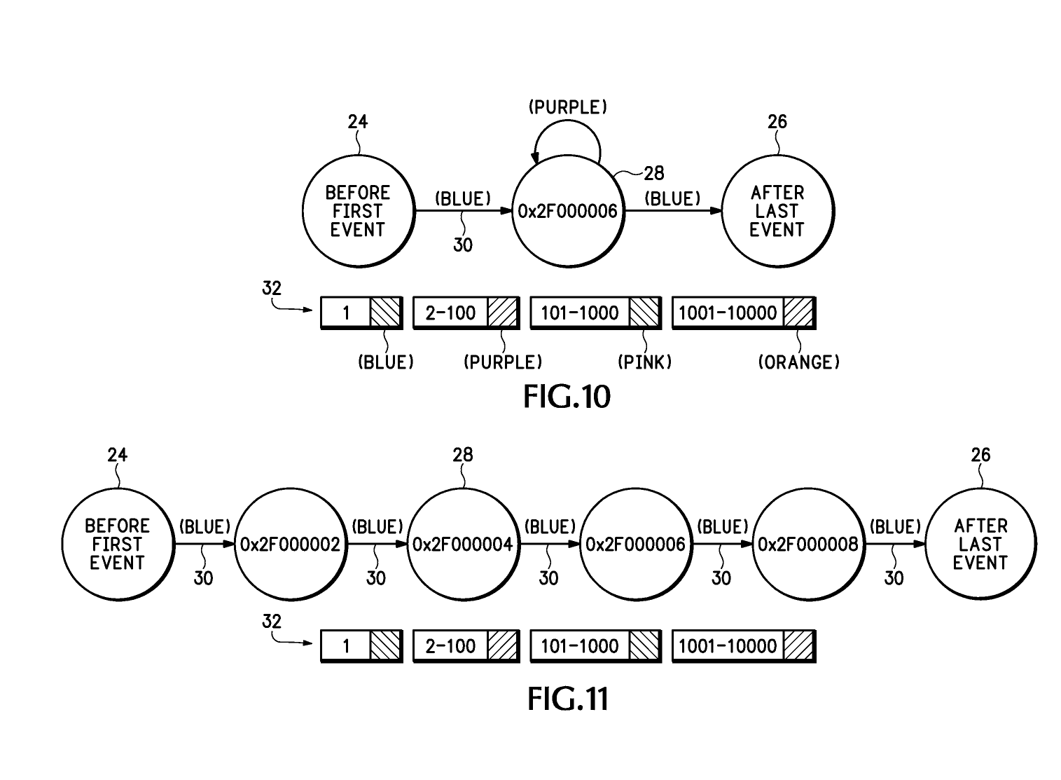

Alternatively the events may be produced as bubbles on a graphic display with lines in the form of arrows interconnecting the bubbles to give a state machine representation, as shown in FIGS. 10-14 and described below. For each state or event change a path is assigned as a line indicating the direction of the transition from one event to the next, and the number of times that each unique path is traversed is incremented at each event change. When the entire acquired digital data is processed, then the bubbles are displayed together with the unique paths between them representing the transition paths. The color of the transition paths is determined by the associated count of the number of times that path was followed.

FIG. 10 is a single event flow sequence view. There are three elements 24, 26, 28—the “Before First Event” and “After Last Event” bubbles 24, 26 represent the range of “events” 28 that are included in the view. The bubbles are connected by lines 30, with the color of the lines representing the number of times that transition path is followed within a defined range as given by a key 32. The ranges may be “1”, “2-100”, “101-1000” and “1001-10000” as shown in this example. In this instance the color of the lines connecting the “event” bubble 28 having an address 0x2F000006 to the “Before First Event” and “After Last Event” bubbles 24, 26 are colored to represent the quantity “1”, and the loop for the single event bubble is colored to represent the range “2-100”, i.e., there is a single entry path to the event bubble, a single exit path from the event bubble and the event occurred between 2-100 times.

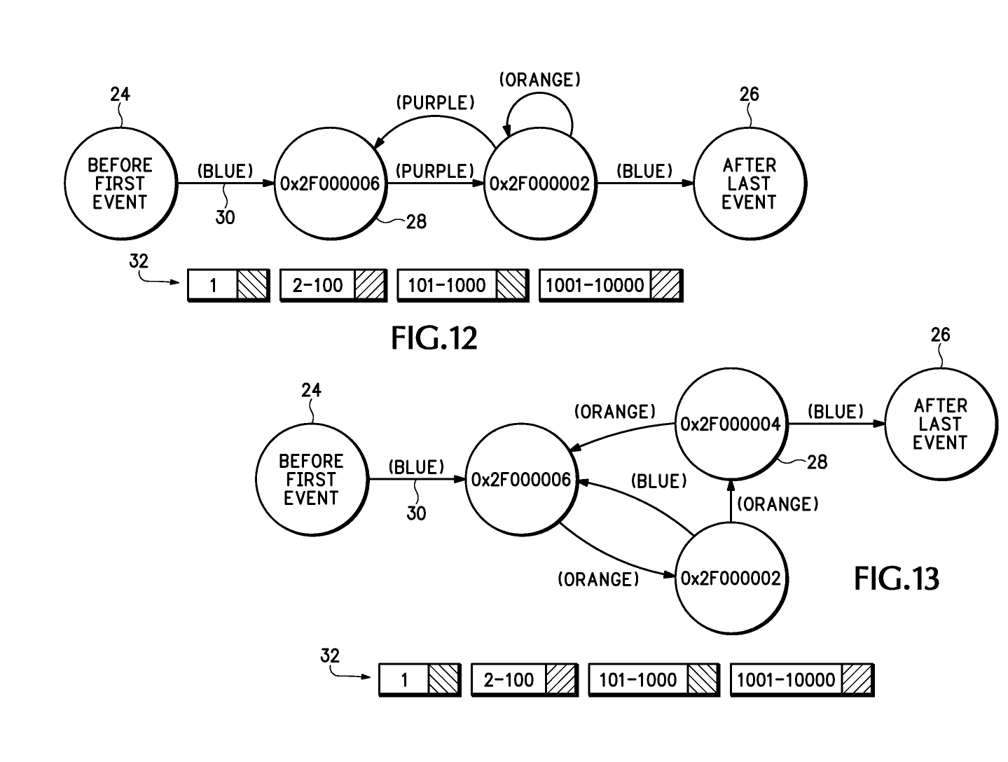

FIG. 11 shows a sequence of four events 28, with each event occurring once in sequence. FIG. 12 shows a more complex acquisition where a first event bubble has a single entry path and a second event bubble has a single exit path, but the two events loop with each other 2-100 times and the second event also loops with itself 1001-10000 times. In other words the event with address 0x2F000002 occurred most of the time versus much fewer events with the address 0x2F000006. FIG. 13 shows an even more complex acquisition with three events where the majority of sequences take a 0x2F000006, 0x2F000002, 0x2F000004 back to 0x2F000006 path repeatedly. There is however one path that doesn't follow the others and it stands out—the single instance where the path goes from event 0x2F000002 to 0x2F000006. The likelihood of the user finding this one aberration in a listing or waveform view is doubtful, and may even be difficult with the event driven data view. However in this event flow sequence view the aberration is clear. Sifting through mega-bytes of acquired data samples looking for something wrong is ordinarily a pretty monumental task without having the event flow sequence view described here.

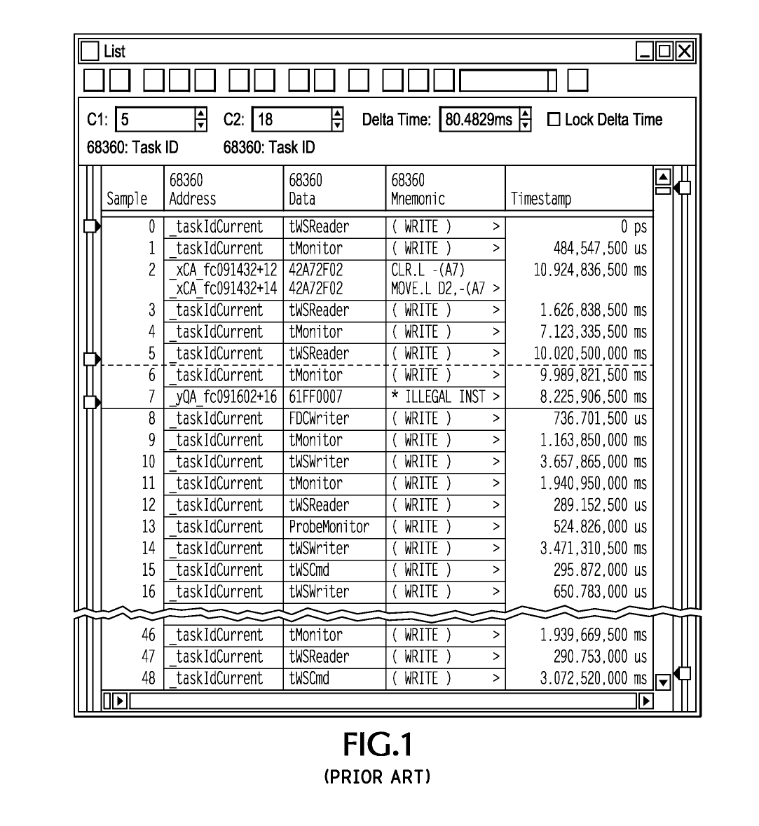

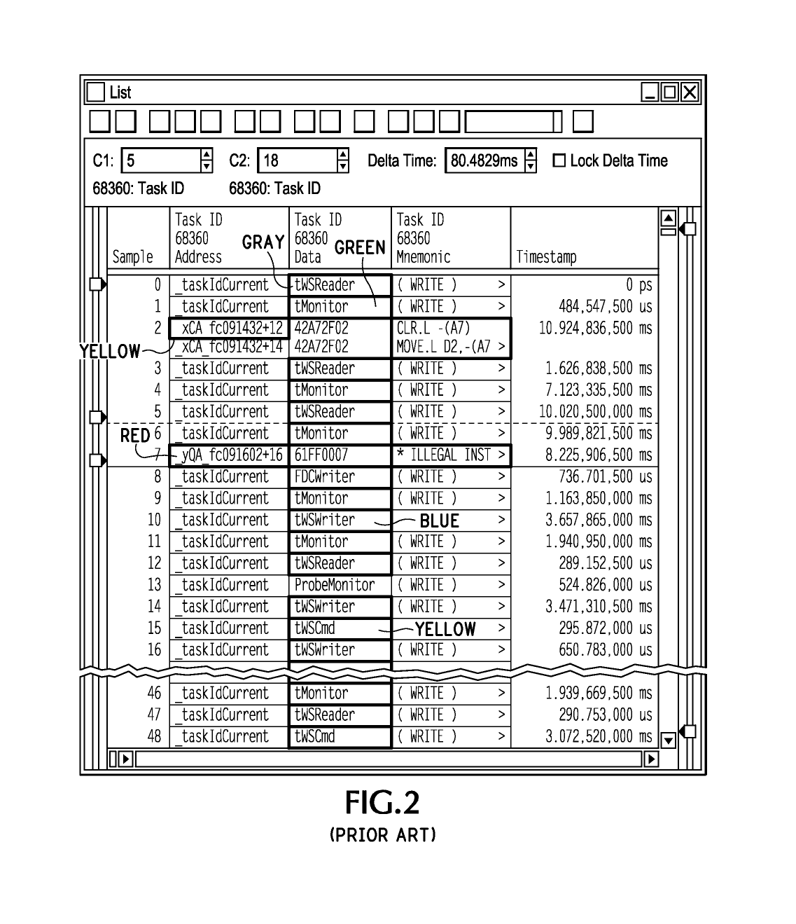

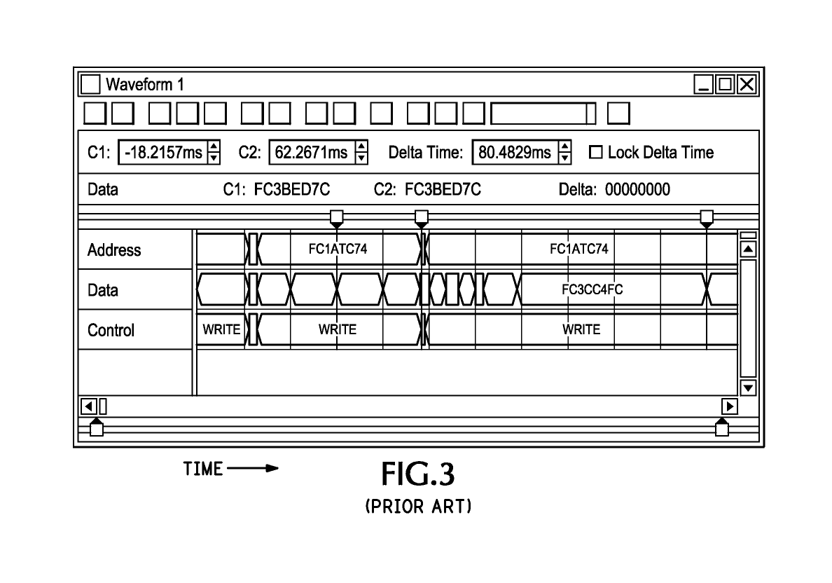

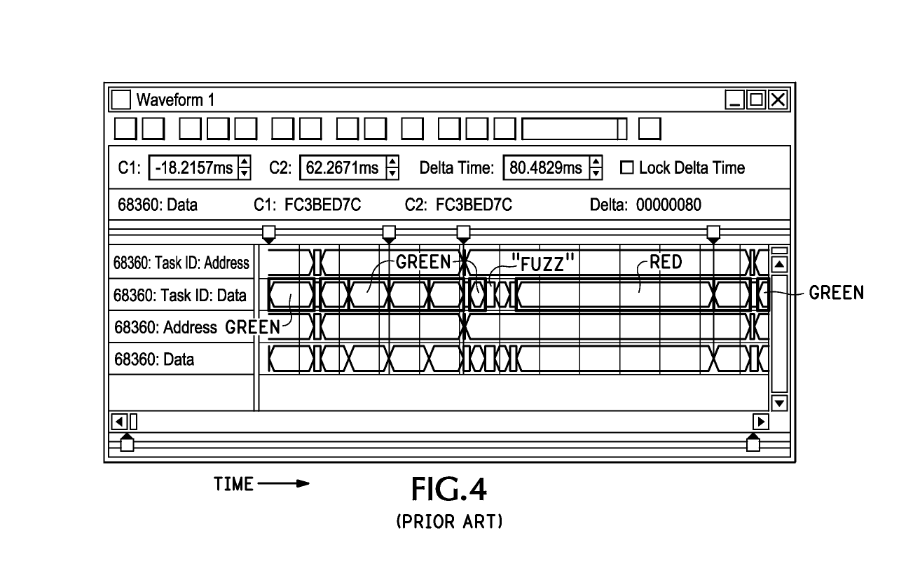

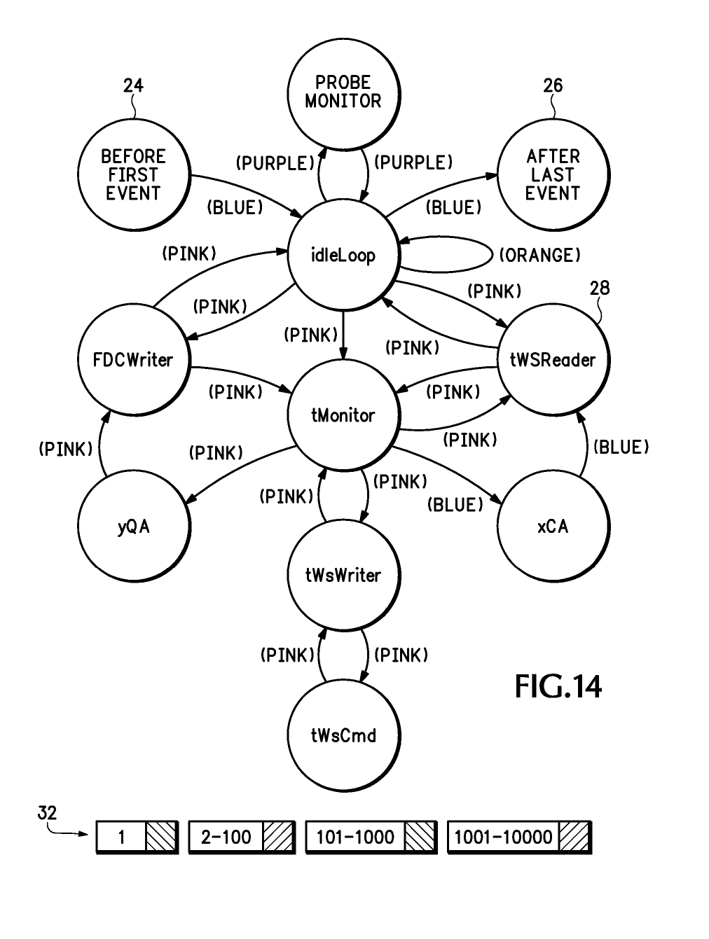

Referring back to FIG. 1 a very complex sequence of events is represented. The acquired digital data in the listing represents a capture of a current task ID being updated by a RTOS. The event flow sequence of FIG. 14, however, is a representation of that acquisition. The acquisition starts at an “idleLoop” with most of the activity, on the order of 101-1000 times, occurring with events “yQA”, “FDCwriter”, “tWSReader”, “tMonitor”, “tWSWriter”, and “tWSCmd” with a single loop from “tMonitor” to “xCA” back to “tWSReader”. However there is a loop back to “idleLoop” that is in the range of 1001-10000, i.e., most of the time is spent idling. This is a clue to the user that there is something that needs addressing in order to maximize the efficiency of the sequence of events versus time and to minimize the idle time.

Each event may be defined as some hardware state of the user's state machine, and be further defined as address ranges of functions so that the user may follow and measure the execution of one or more function interactions within a particular event. In the same way that the events may be shown in the event driven data view, the functions of a selected one of the events also may be shown to find which functions within the event are consuming the most time.

Thus the present invention provides a macro-level digital data event display that parses events and provides them either as events versus time or as a flow sequence comparable to a state diagram so that the user may readily analyze large amounts of acquired digital data to locate regions of interest.

What is claimed is:

1. A method of displaying large amounts of acquired digital data comprising the steps of:
defining unique events within the acquired digital data;
locating the defined events within the acquired digital data; and
providing an event-based view for display indicative of event activity represented by a portion of the acquired digital data.

2. The method as recited in claim 1 wherein the providing step comprises the steps of:
labeling each of the defined events along one axis of a first graph to define a plurality of lines that extend along a second axis of the graph that represents time; and
extending a bar along the second axis of the first graph, the bar switching from line to line according to sequential changes from one defined event to the next within the acquired digital data to show event sequences.

3. The method as recited in claim 2 wherein the providing step further comprises the steps of:
coloring each label uniquely, the color for each event being determined in the defining step; and
changing a color of the bar as it changes from line to line to match the color of the label associated with the line.

4. The method as recited in claim 2 wherein the providing step further comprises the step of collapsing a plurality of the defined events into a single line having a sequence label representing a specific sequence of defined events.

5. The method as recited in claim 4 wherein the providing step comprises the steps of:
coloring each label uniquely, the color for each event label being determined in the defining step and the color of the sequence label being determined in the collapsing step; and
changing a color of the bar as it changes from line to line to match the color of the defined event associated with the line; and
changing the color of the bar within the line representing the specific sequence to correspond to the color of each defined event within the specific sequence.

6. The method as recited in claim 2 further comprising a second graph based upon another set of acquired digital data placed in juxtaposition with the first graph so that relationships between events from the different sets of acquired digital data may be readily apparent.

7. The method as recited in claim 1 wherein the providing step comprises the steps of:
providing a graphic symbol for each defined event; and
drawing lines between the graphic symbols representing transitions from one defined event to another to produce a state machine representation of the acquired digital data.

8. The method as recited in claim 7 wherein the drawing step comprises the step of assigning a specific color to each line according to the number of times the transition represented by the line occurred within the acquired digital data.

9. The method as recited in claim 8 wherein the assigning step comprises the step of assigning a range of values to each specific color.

10. The method as recited in claim 9 wherein the providing step further comprises the step of providing a key that relates each range of values with each specific color.

11. A event-based display for large amounts of acquired digital data comprising:
a first graph having a first axis and a second axis;
a plurality of labels representing unique defined events derived from the acquired digital data along the first axis, each label defining a line along the second axis as time; and
a bar extending along the second axis, the bar switching from line to line sequentially as the defined events change and indicating an amount of time spent in each of the defined events.

12. The display as recited in claim 11 wherein the plurality of labels are each assigned a unique color, and the bar changes color as it changes from line to line according to the color of the label for the line.

13. The display as recited in claim 11 further comprising a sequence label representing a specified sequence of the defined event so that a plurality of the defined events are collapsed to a single line.

14. The display as recited in claim 13 wherein the plurality of labels are each assigned a unique color, and the bar changes color as it changes from line to line according to the color of the label for the line and changes color along the line having the sequence label as each of the collapsed defined events occurs.

15. The display as recited in claim 11 further comprising a second graph similar to the first graph that represents another set of acquired digital data, the second graph being positioned relative to the first graph so that relationships of the defined events between the sets of acquired digital data are readily apparent.

16. An event-based display for large amounts of acquired digital data comprising:
a plurality of graphic symbols, one for each unique defined event represented in the acquired digital data; and
lines interconnecting the graphic symbols to indicate transitions from one defined event to another within the acquired digital data to produce a state machine representation for the acquired digital data.

17. The display as recited in claim 16 wherein each line is assigned a unique color according to a number of times the transition represented by the line occurred within the acquired digital data.

18. The display as recited in claim 17 wherein each unique color represents a different range of values.

19. The display as recited in claim 18 further comprising a key that correlates each unique color to a corresponding one of the range of values.
